(19) United States
(12) Patent Application Publication
(10) Pub. No.: US 2018/0195905 A1
(43) Pub. Date: Jul. 12, 2018

(54) Sweep Control of an Optical Heterodyne Measurement System

(71) Applicant: Finisar Corporation, Horsham, PA (US)

(72) Inventors: Simon Poole, Rosebery (AU); Cibby Pulikkaseril, Rosebery (AU); Qing Li, Rosebery (AU); Nikhil Cunha, Rosebery (AU); Harold Rosenfeldt, Arncliffe (AU)

(73) Assignee: Finisar Corporation, Horsham, PA (US)

(21) Appl. No.: 15/746,400

(22) PCT Filed: Jul. 25, 2016
(86) PCT No.: PCT/US16/43947

§ 371 Date: Jan. 19, 2018

Related U.S. Application Data
(60) Provisional application No. 62/197,309, filed on Jul. 27, 2015.

(51) Int. Cl. G01J 3/433; G01J 3/10

(52) U.S. Cl. CPC G01J 3/433; G01J 9/04; G01J 3/10

(57) ABSTRACT

Described herein is a system and method of controlling an optical heterodyne measurement system (1). The measurement system (1) has a tunable laser (9) for generating a local oscillator signal, an optical input (5) for receiving an input optical signal (7) and a mixing module (13) for mixing the local oscillator signal with the input optical signal to generate an output optical measurement signal. One embodiment provides a method including the steps of: a) receiving an input electrical drive signal for driving the tunable laser (9) to produce a laser output having a spectral linewidth and peak central frequency; b) coupling the input electrical drive signal with an electrical linewidth control signal (54) to selectively broaden the spectral linewidth; and c) during a measurement period, selectively tuning the central frequency of the laser in a stepwise manner across a predetermined frequency spectrum at predefined tuning increments.

### FIELD OF THE INVENTION

The present invention relates to optical heterodyne measurement systems and in particular to a control system for a high resolution optical heterodyne measurement system. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In optical heterodyne measurement systems, a reference laser beam is used as a local oscillator signal to mix nonlinearly with an input optical signal to produce a mixed output signal. The output signal contains information on the amplitude and phase of the input optical signal at frequencies close to the frequency of the local oscillator signal. Thus, by tuning the frequency of the local oscillator signal (using a tunable laser), the amplitude and phase information of the input optical signal can be measured across a range of frequencies.

Because optical heterodyne measurement systems extract signal information at frequencies close to the local oscillator frequency, these systems are sometimes referred to as coherent detection systems.

Example optical heterodyne measurement systems include optical spectral analyzers (OSAs), which measure the fine structure of optical spectra at high resolutions, and optical channel monitors (OCMs), which aim to measure the optical power of optical channels, typically on a broader spectral scale than OSAs. By way of example, US Patent Application Publication 2015/0086198 A1 to Frisken et al. entitled “Ultrafast High Resolution Optical Channel Monitor” (hereinafter “Frisken et al.”) relates to a compact and reconfigurable high resolution optical channel monitor that relies on heterodyne detection. This and related high resolution OCM devices will be referred to herein as a HR-OCM.

The HR-OCM is an extremely high resolution OCM, where the fundamental resolution of the device is limited to the electronic bandwidth in the heterodyne detection receiver. An important aspect of OCMs is the time taken for the device to complete a sweep of the optical spectrum being monitored. To ensure an OCM performs a comprehensive scan or sweep of a desired spectrum without spectral gaps, the tunable reference laser should step through the spectrum with maximum increments given by its spectral linewidth. The spectral linewidth of a laser represents the spectral width of the peak laser signal, typically measured by its full width half maximum (FWHM).

High resolution devices such as OSAs and the HR-OCM have a small reference laser linewidth in which spectral measurements are taken so a sweep of a broad spectrum requires a large number of laser frequency steps. Typically, an HR-OCM measures greater spectral detail at the cost of a slower sweep time. Conversely, a low resolution OCM provides less spectral detail at a higher sweep rate. A similar trade-off exists in OSAs, including the Finisar WaveAnalyzer 1500S High-Resolution Optical Spectrum Analyzer.

Many applications require the channel or system spectrum to be monitored very rapidly. Accordingly, one technique to reduce the sweep time of a HR-OCM or OSA is to sample select portions of the total spectrum. However, this necessarily leaves spectral gaps where no spectral information can be obtained and therefore negates the resolution advantages associated with a HR-OCM. Thus, without a complex optical system, a large number of laser steps must be used to sweep a high resolution optical heterodyne measurement device across a wide frequency band. Not only does this increase the overall sweep time of the device, it can also add complexity to the overall system design in terms of firmware, software and calibration.

Therefore, improved techniques for rapidly sweeping a high resolution OCM are desired.

### SUMMARY OF THE INVENTION

In accordance with a first aspect of the present invention there is provided a method of controlling an optical heterodyne measurement system, the measurement system having a tunable laser for generating a local oscillator signal, an optical input for receiving an input optical signal and a mixing module for mixing the local oscillator signal with the input optical signal to generate an output optical measurement signal; the method including the steps of:
a) receiving an input electrical drive signal for driving the tunable laser to produce a laser output having a spectral linewidth and peak central frequency, an initial spectral linewidth of the laser output having a first spectral width;
b) coupling the input electrical drive signal with an electrical linewidth control signal to selectively broaden the spectral linewidth to a second spectral width; and
c) during a measurement period, selectively tuning the central frequency of the laser in a stepwise manner across a predetermined frequency spectrum at predefined tuning increments.

In some embodiments the tuning increment is defined based on the second spectral width. In some embodiments the tuning increment is in the range of 0.5 to 1.5 times the second spectral width. In one particular embodiment the tuning increment is equal to the second spectral width.

In one embodiment the linewidth control signal is based on user input indicative of a desired scan time or refresh rate of the optical heterodyne measurement system. In one embodiment the linewidth control signal includes a pseudo random bit function. In another embodiment the linewidth control signal includes a repeating triangular function. In a further embodiment the linewidth control signal includes a sinusoidal function.

In one embodiment the input electrical drive signal controls the gain of the tunable laser. In another embodiment the electrical drive signal controls the phase of the tunable laser.

In one embodiment the second spectral width is proportional to the amplitude of the linewidth control signal. Preferably the second spectral width is 5 to 100 times greater than the first spectral width.

In one embodiment the linewidth control signal also modifies the spectral profile of the laser. Preferably the linewidth control signal flattens the spectral profile of the laser.

In one embodiment the tuning increment is variable over a given frequency range.

In one embodiment step b) includes modulating the input electrical drive signal with a linewidth control signal.

In some embodiments the linewidth control signal is dynamic. In one embodiment the linewidth control signal varies as a function of the central frequency of the tunable laser so as to vary the second spectral width during the measurement period.

In accordance with a second aspect of the present invention there is provided a control system for an optical heterodyne measurement system, the measurement system having a tunable laser for generating a local oscillator signal, an optical input for receiving an input optical signal and a mixing module for mixing the local oscillator signal with the input optical signal to generate an output optical measurement signal, the control system including:
a drive module for producing an input electrical drive signal for driving the tunable laser to produce an optical output having a spectral linewidth and peak central frequency, an initial spectral linewidth of the laser output having a first spectral width;
a linewidth tuning module for coupling the input electrical drive signal with an electrical control signal to selectively broaden the spectral linewidth to a second spectral width; and
a tuning module for selectively tuning the central frequency of the laser in a stepwise manner across a predetermined frequency spectrum.

In one embodiment the tuning module selectively tunes the central frequency at integer multiples of a tuning increment, wherein the tuning increment is defined based on the second spectral width.

In one embodiment the linewidth control signal is dynamic so at to allow variation of the second spectral width as a function of the central frequency of the laser.

In accordance with a third aspect of the present invention there is provided a method of calibrating a tunable laser including the steps of:
a) performing a first measurement of a spectral linewidth of the laser output;
b) coupling the input electrical drive signal with an electrical control signal to selectively broaden the spectral linewidth;
c) performing a second measurement of the spectral linewidth; and
d) defining a tuning increment based on the second measurement such that, during operation, the central frequency of the laser is incrementally tuned in a stepwise manner across a predetermined frequency spectrum at integer multiples of the tuning increment.

In accordance with a fourth aspect of the present invention there is provided an optical heterodyne measurement system including:
an optical input for receiving an input optical signal;
a tunable laser for generating a local oscillator signal;
a mixing module for mixing the local oscillator signal with the input optical signal to generate an output optical measurement signal,
a signal generator for generating an electrical control signal; and
a modulator for modulating the input optical signal with the electrical control signal to spectrally broaden the input optical signal prior to mixing with the local oscillator signal.

### BRIEF DESCRIPTION OF THE DRAWINGS

Preferred embodiments of the disclosure will now be described, by way of example only, with reference to the accompanying drawings in which:

FIG. 1 is schematic plan view of an exemplary HR-OCM 1 as described in Frisken et al;

FIG. 2 is a schematic plan view of the optical channel monitor of FIGS. 1 and 2 illustrating exemplary beam trajectories from both an input signal and the laser.

FIG. 3 is a schematic plan view of a Finisar S7500 tunable laser and associated input control signals;

FIG. 4 illustrates a process flow of a method of controlling an optical heterodyne measurement system;

FIG. 5 illustrates a Gaussian spectral profile of a conventional laser signal;

FIG. 6 a schematic plan view of a Finisar S7500 tunable laser and associated input control signals from a microcontroller which has capability to couple the signals with a linewidth control signal;

FIG. 7 is a graph comparing power repeatability across frequency for five different linewidth control signals;

FIG. 8 illustrates an exemplary spectral measurement, before and after linewidth broadening;

FIG. 9 schematically illustrates a slow sweep of a spectrum at a higher resolution (small linewidth) and smaller tuning increment (equal to the linewidth;

FIG. 10 schematically illustrates a fast sweep of spectrum at a lower resolution (larger linewidth) and larger tuning increment (equal to the larger linewidth); and

FIG. 11 illustrates schematically an alternative embodiment of the invention wherein spectral broadening is applied to the input signal.

### DETAILED DESCRIPTION

Embodiments of the present invention will be described with reference to an HR-OCM as described in Frisken et al. However, it will be appreciated that the present invention is applicable to various other optical heterodyne measurement systems including OSAs.

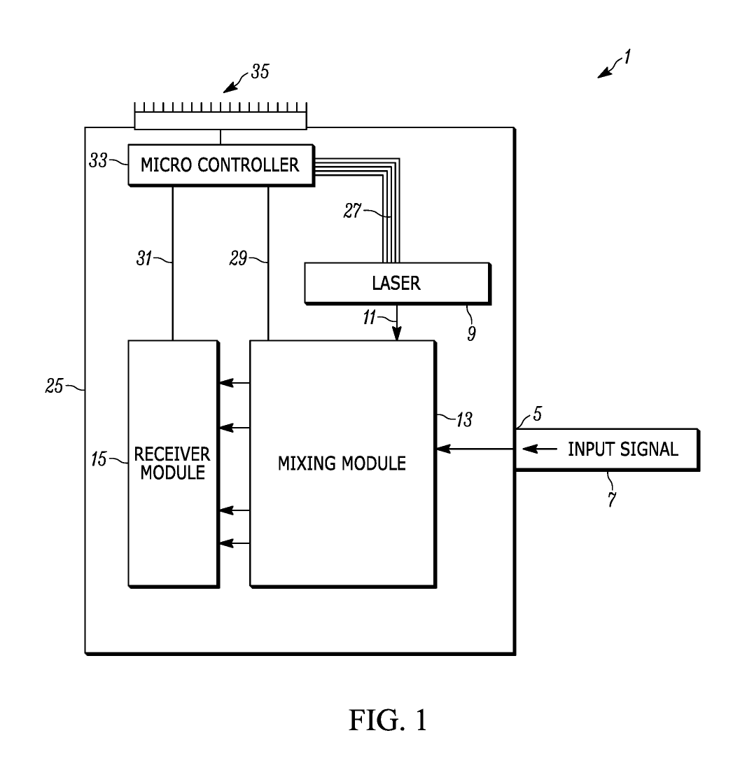

Referring to FIG. 1 there is illustrated a schematic plan view of an exemplary HR-OCM 1 of Frisken et al. OCM 1 includes an outer protective housing 3 for hermetically sealing the components therein. An input port 5 is disposed in housing 3 and is configured for receiving an input optical signal 7 including one or more optical channels separated by wavelength and frequency. A tunable laser 9 is located within housing 3 and is configured to provide an optical reference signal 11 at a reference frequency f₀ and a natural linewidth Δv. By way of example, in one embodiment, laser 9 is a Finisar S7500 tunable semiconductor type laser adapted to sweep step-wise across the entire optical C-band of frequencies in increments of 1 GHz. Operation of the Finisar S7500 laser is described below. More generally, laser 9 is adapted to sweep continuously or semi continuously across a predefined frequency band covering the wavelength channels. In some embodiments, other types of lasers are utilized. In some embodiments, laser 9 includes a wavelength referencing element which provides for absolute frequency registration and wavelength correction for temperature fluctuations. In a further embodiment, laser 9 is located external to housing 3 or within a separate housing.

An optical mixing module 13 is coupled to input port 5 and laser 9, and mixes input signal 7 with reference signal 11 to produce a mixed output signal. Mixing module 13 is able to optically mix the input signal 7 with the reference signal 11 in a number of ways. Exemplary operation of the mixing module 13 is described in detail in Frisken et al. The contents of this related application are incorporated herein by way of cross-reference.

A receiver module 15, having four photodiodes 17, 19, 21 and 23, is configured to receive the mixed output signal and extract signal information indicative of the optical power of input signal 7 at the reference frequency f₀. In this manner, by setting the reference frequency f₀ to the frequency of an optical channel, characteristics of that optical channel can be monitored. By sweeping the reference frequency f₀ across a range of frequencies, the characteristics of a number of optical channels can be monitored in a time division manner.

Laser 9, mixing module 13 and receiver module 15 are all mounted to a substrate 25 in the form of a printed circuit board within housing 3. Substrate 25 includes electrical interconnections, for example 27, 29 and 31, between the different elements and a central microcontroller 33. Microcontroller 33 includes control and signal processing electronics for electrically controlling various aspects of the device, including laser gain, laser center frequency, thermo-electric coolers, photodiode controls and data output to an external processor (not shown). Housing 3 also includes a plurality of electrical pins 35 that are connected to microcontroller 33. Electrical pins 35 allow connection of OCM 1 to an external control system (not shown) for controlling OCM 1 and extracting data obtained by OCM 1. It will be appreciated that the layout illustrated in FIG. 1 is only an exemplary layout of elements on substrate 25. It will be appreciated by persons skilled in the art that OCM 1 can be implemented in various layouts without departing from the scope of this disclosure.

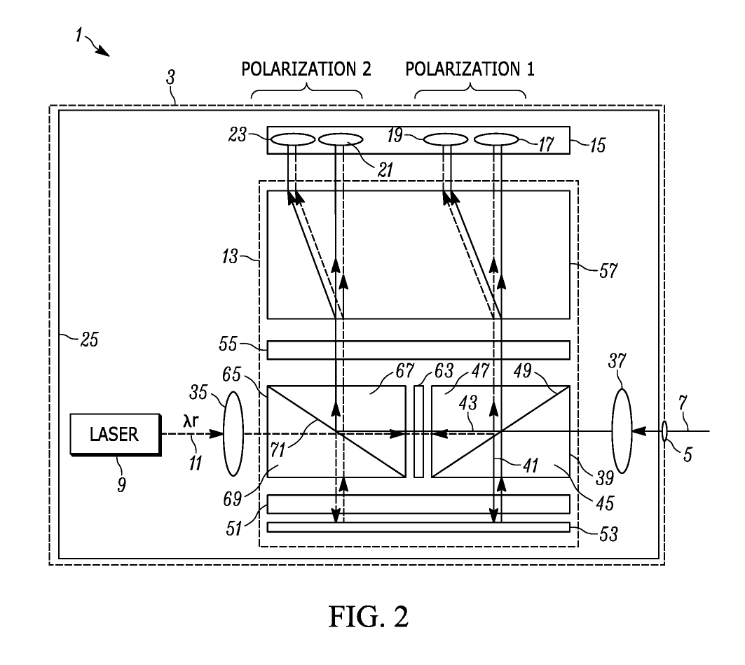

The exemplary operation of the mixing module 13 is now briefly described with reference to FIG. 2. More details of the operation of mixing module 13 are described in Frisken et al., which utilizes a recent development in coherent detection described in U.S. Pat. No. 8,526,830 entitled “High bandwidth demodulator system and method” to inventor Steven Frisken and assigned to Finisar Corporation. The contents of this related application are also incorporated herein by way of cross-reference.

Initially, reference signal 11 is coupled from laser 9 to mixing module 13 through a collimating lens 35. Similarly, input signal 7 is coupled from input port 5 to mixing module 13 through a single collimating lens 37. The overall operation of mixing module 13 is to divide the input and reference signals into respective first and second orthogonal polarization components and to mix these orthogonal components together. In particular, mixing module 13 mixes a first orthogonal signal polarization component with a second orthogonal reference polarization component and mixes a second orthogonal signal polarization component with a first orthogonal reference polarization component.

Mixing module 13 includes a first polarization beam splitter 39 for spatially separating input signal 7 into first and second orthogonal signal polarization components 41 and 43. Beam splitter 39 is substantially rectangular in cross section and includes two wedge-shaped elements 45 and 47 of glass material, which define a central angled interface 49. Interface 49 includes a dielectric coating which allows one polarization component to pass while reflecting the orthogonal component.

Input signal 7 propagates through first wedge-shaped element 45 and is incident onto interface 49 where first polarization component 41 (shown as a vertical component in FIG. 2) is reflected and second orthogonal polarization component 43 (shown as a component into/out of the page in FIG. 1) is transmitted.

The reflected polarization component 41 is passed through a first polarization manipulation or transformation element, in the form of a quarter-wave plate 51 and mirror 53. First signal polarization component 41 passes through quarter-wave plate 51, is reflected off mirror 53 and passes again through quarter-wave plate 51. After the second pass of quarter-wave plate 51, component 41 is rotated by 90° into the orthogonal orientation (vertical in FIG. 2).

Component 41 is then passed back through beam splitter 39 where it passes directly through interface 49 due to its now orthogonal polarization orientation. After passing through beam splitter 39, component 41 is passed through a second polarization manipulation element in the form of a second quarter-wave plate 55. Quarter-wave plate 55 manipulates component 41 into a circular polarization state (illustrated as a 45° component) before component 41 reaches a polarization separation element in the form of a walk-off crystal 57.

Walk-off crystal 57 spatially separates component 41 into two constituent orthogonal polarization sub-components 59 and 61. The thickness of crystal 57 is chosen so that sub-components 59 and 61 are separated by a predetermined distance and, at the output of crystal 57, the sub-components are each incident onto two respective adjacent photodiodes 17 and 19.

Turning now to component 39, after transmission through interface 49 of beam splitter 39, component 43 traverses second wedge-shaped element 47 unimpeded and unmodified and is passed through a half-wave plate 63. Wave plate 63 manipulates component 43 to return an orthogonal polarization orientation (into/out of the page in FIG. 2). Component 43 then passes to a second polarization beam splitter 65, which includes two wedge-shaped elements 67 and 69 having different refractive indices. Beam splitter 65 is equivalent in operation to beam splitter 39 described above but is oppositely oriented. In some embodiments, beam splitters 39 and 65 and half-wave plate 63 are connected to form an integral component.

Component 43 passes through wedge-shaped element 67 and is reflected off an interface 71 at the connection between elements 67 and 69. Component 43 is directed upward through element 67 and traverses through quarter-wave plate 55 where it is manipulated into a circular polarization. Component 43 then traverses walk-off crystal 57 where it is spatially separated into two orthogonal polarization sub-components 73 and 75 having the same respective polarization orientations as sub-components 59 and 61. Components 73 and 75 emerge from crystal 57 and are received by respective photodiodes 21 and 23 in receiver module 15.

Reference signal 11 propagates through OCM 1 simultaneously with input signal 7. OCM 1 processes reference signal 11 in a similar manner to that described above in relation to input signal 7.

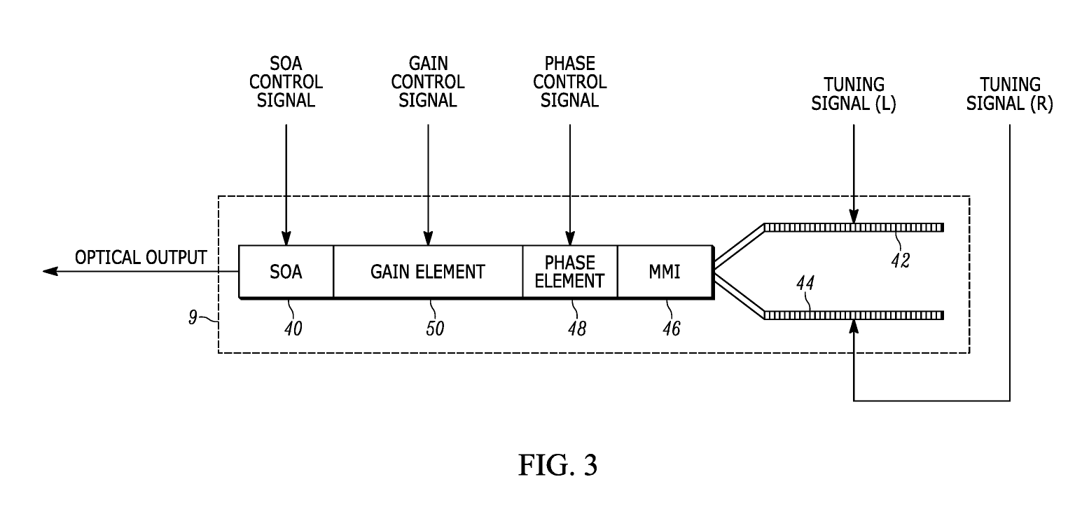

Referring now to FIG. 3, there is illustrated a schematic plan view of laser 9, which represents a Finisar S7500 laser mentioned above. Operation of the heterodyne system using a Finisar S7500 laser is described in an exemplary sense only to highlight how the laser inputs are controlled to specify a laser linewidth. It will be appreciated by a person skilled in the art that various other types of tunable lasers are able to be controlled in a similar manner.

The Finisar S7500 incorporates a monolithic InP semiconductor chip that integrates a tunable modulated grating Y-branch (MG-Y) fiber laser cavity with a semiconductor optical amplifier (SOA) gain medium 40. Each branch of the MG-Y cavity includes an electronically tunable narrowband distributed Bragg reflector (DFB) 42 and 44. Each reflector produces a comb-shaped reflectivity spectrum, which is combined using a multi-mode interference (MMI) coupler 46. The combs have slightly different peak separations, such that only one pair of peaks overlap at any time. A large reflection only occurs at the frequency where a reflectivity peak from the left reflector is aligned with a reflectivity peak from the right reflector. The laser will thus emit light at the frequency of the longitudinal cavity mode that is closest to the peak of the aggregate reflection. By tuning one of the reflectors by an amount equal to the difference in peak separation, an adjacent pair of peaks can be aligned, i.e. a large tuning of the emission frequency (wavelength) is obtained for a relatively small tuning of a single reflector.

Tuning of the central laser frequency is performed by electronically varying the relative change in the refractive index of the DFBs and also by varying the roundtrip phase of the optical cavity using a phase element 48. Optical gain in the cavity is provided by a gain element 50 formed of an optical gain material.

Like other tunable lasers, tuning and operation is controlled by electrical inputs from a control circuit. In particular, the Finisar S7500 laser is controlled by five separate input control signals, each software controlled by a microcontroller chip. The application code in the microcontroller runs the control algorithms for frequency and power control and handles communications with external devices over connections such as an RS-232 serial connection. The laser can be fully controlled internally or from an external computer by inputting the following five input control signals:
1) A left reflector control signal, which tunes the refractive index of DFB 42;
2) A right reflector control signal which tunes the refractive index of DFB 44;
3) A phase control signal which tunes phase element 48 to control the roundtrip phase of the optical cavity;
4) A gain control signal which varies the gain of element 50 to control the overall gain of the laser; and
5) A SOA control signal to control the amplification provided by SOA 40.

Signals 1) to 3) provide for frequency tuning and signals 4) and 5) provide power tuning. Full frequency tuning coverage is achieved by selectively varying signals 1) and 2) to control the temperature/length of the left and right reflector arm of the laser cavity in conjunction with signal 3) to vary the roundtrip phase of the overall cavity. Signal 4) controls the amount of gain provided by the gain element. Adjusting signal 5) varies the current through the SOA, and allows for adjustment of the output power independently from the emission frequency.

The microcontroller 33 accesses lookup tables to relate desired frequency or power inputs to corresponding voltage or current signals for each of the five signals above.

Although tunable lasers have significant flexibility to tune the output frequency and power, one limitation is the inability to vary the linewidth of the laser. Under normal operating conditions, the Finisar S7500 laser has a Lorentzian linewidth of about 5 MHz (at Full Width Half Maximum). When incorporated into a measurement system such as an HR-OSA, the resulting effective linewidth broadens to about 150 MHz. Typical sweep times at this resolution include 1.25 s to scan the C-band (5.2 THz), or 100 ms to scan a smaller region of 400 GHz.

The present invention relates to the control of the laser linewidth in combination with the tuning of the laser central frequency to perform quicker measurements in an optical heterodyne measurement system such as an OCM or OSA.

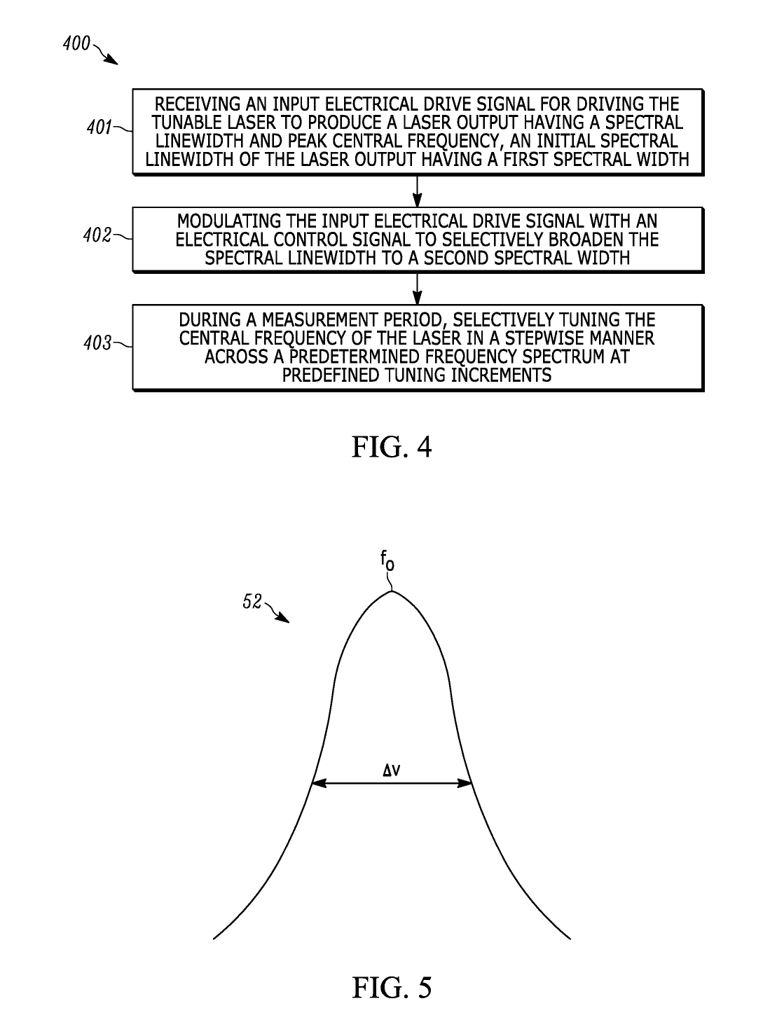

Referring to FIG. 4, there is illustrated a method 400 of controlling an optical heterodyne measurement system such as that illustrated in FIG. 1. Method 400 is adapted to be performed by the microcontroller 33. Method 400 includes the initial step 401 of receiving input electrical drive signals for driving the tunable laser to produce a laser output having an unmodified spectral linewidth (first spectral width) Δv and peak central frequency f₀. A Gaussian spectral profile 52 of a conventional laser beam is illustrated in FIG. 5. In the case of the Finisar S7500 laser, these drive signals include the five signals mentioned above and illustrated in FIG. 3. In the case of other tunable lasers, these signals represent respective phase and gain control signals.

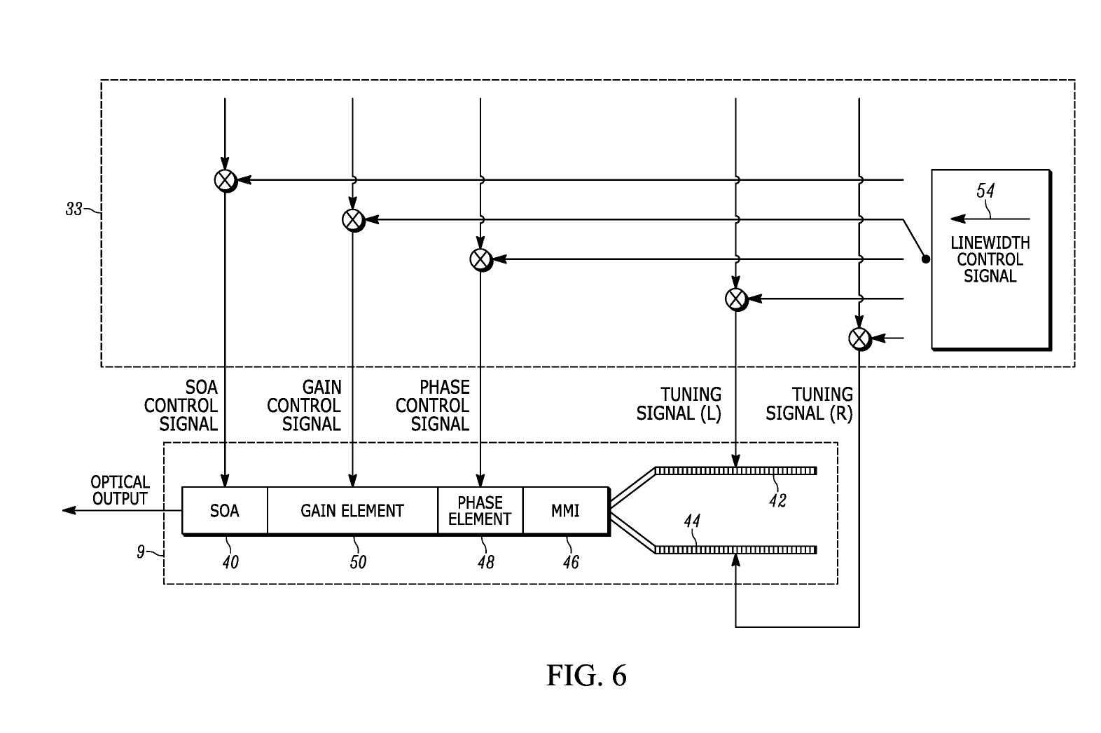

At step 402, one or more of the input electrical drive signals is coupled with an electrical linewidth control signal 54 to selectively broaden the spectral linewidth in a controlled and homogeneous manner to a broadened spectral linewidth (second spectral width) Δv2. This is illustrated schematically in FIG. 6 which shows laser 9 in electrical communication with microcontroller 33. As illustrated, microcontroller 33 is configured to couple or combine the linewidth control signal with any one of the five input control signals described above. Although linewidth control signal 54 is illustrated as being switched to only a single one of the input control signals, it will be appreciated that linewidth control signal 54 can be simultaneously coupled to multiple input control signals. In various applications, the broadened spectral linewidth is preferably 5 to 100 times greater than the first spectral width. Applications requiring very high sweep rates will require greater broadening and applications requiring higher resolution may only require a smaller degree of broadening.

The linewidth control signal 54 can be applied to the input electrical drive signals in a number of ways. Three exemplary techniques include:
a) Hardwiring the signals together using transformer coupling.
b) Configuring a digital to analog converter (DAC) and laser current driver to handle high frequency, and then transmitting the linewidth control signal into the DAC as a modulation waveform.
c) Intentionally configuring the current driver to have poor noise performance by, for example, tuning a digital resistor with the linewidth control signal.

The linewidth control signal acts to controllably increase the noise current in the drive signal to which it is applied, which acts to broaden the linewidth of the laser. The linewidth control signal can be coupled with a gain element or phase element. As the phase element actually tunes the central frequency of the laser, linewidth broadening using phase modulation is actually a fast jitter of optical frequency. Injecting noise to the gain element can also act as a phase modulation by using the appropriate driving signal.

In one exemplary embodiment, the linewidth control signal is a pseudorandom bit sequence (PRBS). The power spectral density of a long length PRBS is significantly similar to a noise source with a Gaussian probability density function, and this can be generated efficiently in digital hardware. Injecting this random noise to the phase tuning current will scatter the frequency of the laser very rapidly, thereby broadening the linewidth on very short time scales. Injecting the noise to the gain current can add additional uncertainty to the beam field of the laser, but not with typical Weiner-Levy statistics (that is, a laser's power spectral density is homogenously broadened by the Wiener-Levy statistics of a time-varying random phase, but it is broadened by current noise and jitter in a manner that is similar to inhomogeneous broadening).

Advantages of using a PRBS signal as the linewidth control signal include the small footprint required on the printed circuit board substrate, the ability to dynamically tune the signal and hence the laser linewidth on the fly, and the ability to generate the PRBS in a Field Programmable Gate Array. A digital to analog converter can be used to control the PRBS signal using software from an external computer device.

A disadvantage of using a long PRBS sequence signal is that it can have large ‘dead zones’ (short intervals of time wherein the PRBS departs from a random nature giving rise to artefacts) on the order of the laser dwell time, and this can cause power fluctuations. Thus, a shorter signal offers more consistent laser operating behavior.

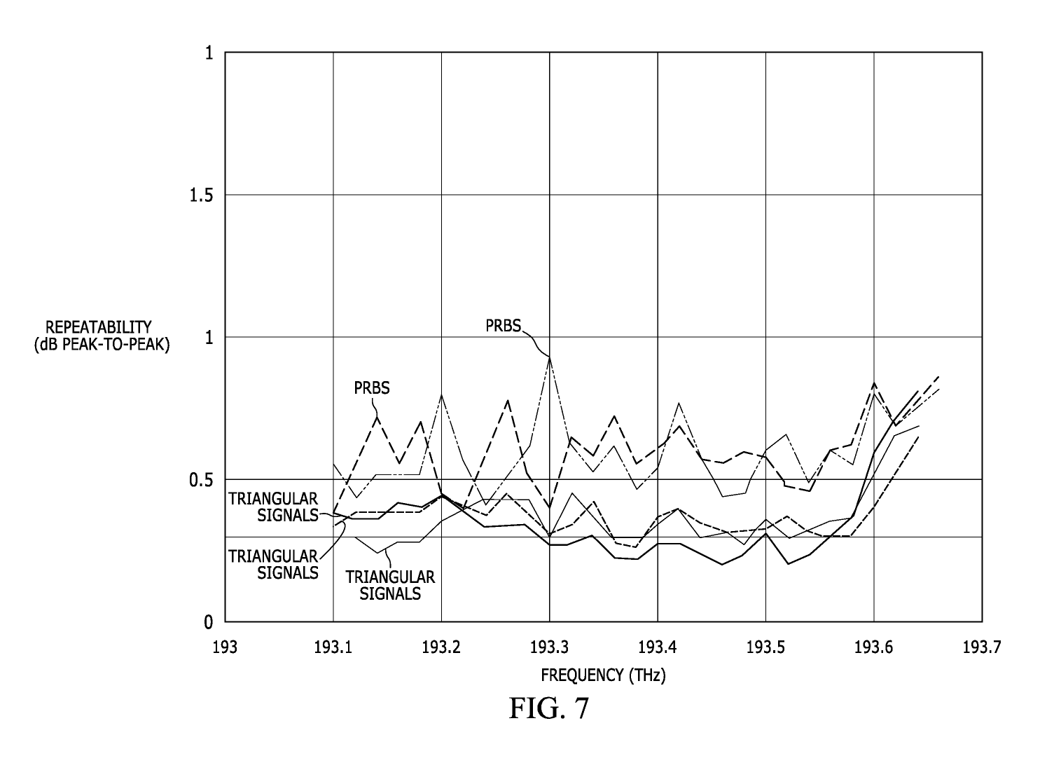

In other exemplary embodiments, the linewidth control signal includes fixed triangular patterns, or sinusoidal patterns. The amplitudes of these patterns can be modified to equalize the power repeatability of a spectral sweep across a range of frequencies. FIG. 7 illustrates a comparison of power repeatability across frequency for five different linewidth control signals; two different PRBS signals and three different triangular signals. As illustrated, the PRBS signals experience the lowest power repeatability since they are long codes that show point-to-point differences.

Power repeatability is enhanced using a wider linewidth local oscillator signal as optical power is averaged over the wider spectral linewidth region.

In another exemplary embodiment, the linewidth control signal includes a clock signal which oscillates between an upper and a lower value. In one particular embodiment the clock signal has a frequency of 100 MHz. More complex linewidth control signals can be derived based on higher order functions having a number of variable coefficients. Variation of these coefficients allows the modification of the overall spectral profile of the laser. In particular, selection of appropriate coefficients can act to flatten the spectral profile of the laser, thereby providing a flat filter profile. Other coefficients can control the roll-off shape of the Gaussian laser spectral beam profile.

The magnitude of the spectral broadening is proportional to the amplitude of the linewidth control signal. A higher amplitude linewidth control signal gives rise to a broader linewidth.

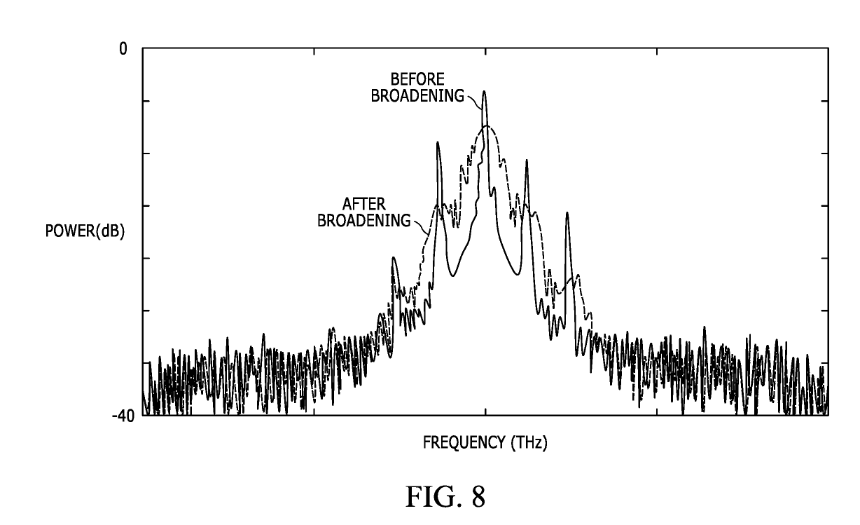

To illustrate the spectral broadening effect, FIG. 8 illustrates an exemplary spectral measurement of a test signal including a frequency comb. After noise injection with a PRBS signal, the measurement clearly has a Gaussian effective filter shape, which indicates that the spectral linewidth has been homogeneously broadened by the PRBS signal.

Referring again to FIG. 4, at step 403, during a measurement period, the central frequency of the laser is selectively tuned in a stepwise manner across a predetermined frequency spectrum at predefined tuning increments. The tuning increment is defined for tuning the central frequency of the laser during measurement of the input optical signal. In the Finisar S7500 laser, the tuning increment is specified by controlling the left and right tuning signals and the phase control signal. In other lasers, the tuning increment is provided by respective tuning control signals.

In some embodiments the tuning increment is defined based on the determined broadened spectral linewidth Δv2. Preferably the tuning increment is approximately equal to the second spectral width such that a comprehensive scan or sweep of a desired spectrum can be performed without spectral gaps. However, in some embodiments, it may be advantageous to set the tuning increment to be smaller or larger than the broadened spectral linewidth. By way of example, the tuning increment may be set to an increment in the range of 0.1 to 2 times the broadened spectral linewidth.

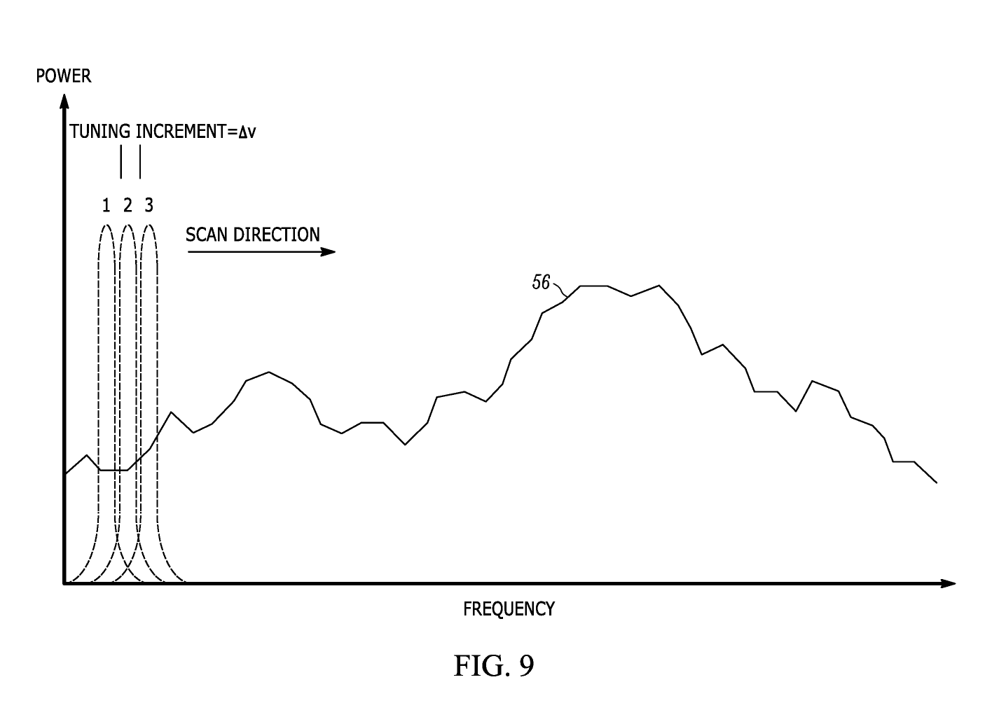

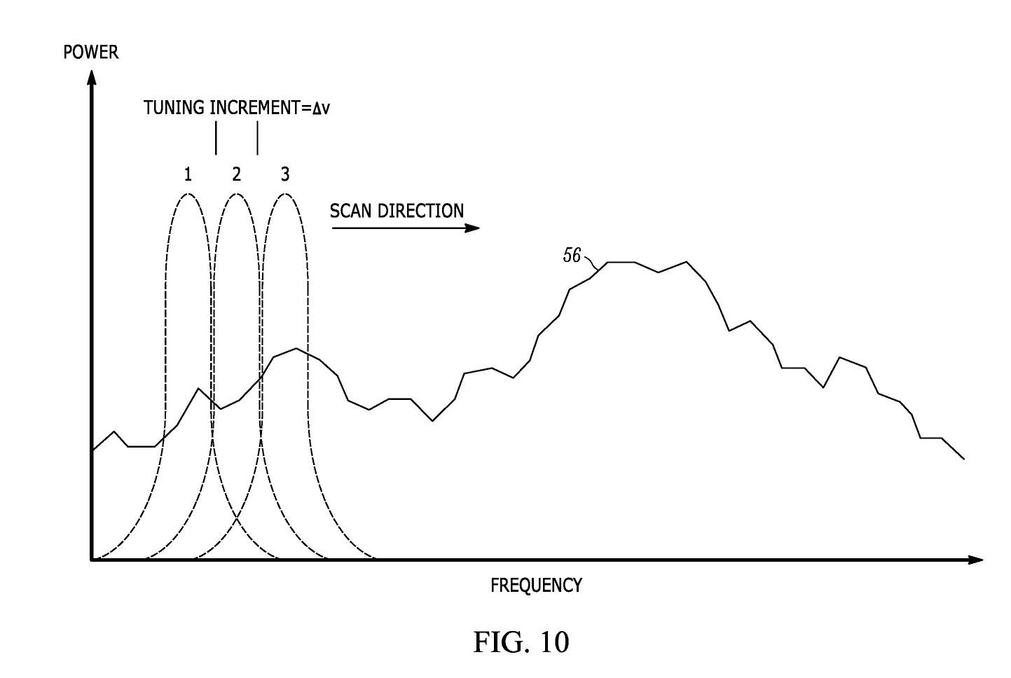

During the measurement by the HR-OCM or OSA, the central frequency of the laser is tuned in a stepwise manner across the desired frequency spectrum at integer multiples of a tuning increment. As the tuning increment is set based on the spectral linewidth of the local oscillator, the number of required increments to sweep the spectrum is also determined by the linewidth so that a broader linewidth provides a quicker sweep of the spectrum. This is illustrated schematically in FIGS. 8 and 9. FIG. 9 illustrates a slower sweep of a spectrum 56 at a higher resolution (narrow linewidth) and smaller tuning increment (equal to the linewidth). FIG. 10 illustrates a faster sweep of spectrum 56 at a lower resolution (larger linewidth) and larger tuning increment (equal to the larger linewidth). The amount of time saved is proportional to the amount of broadening of the laser linewidth. For example, a broadening of the linewidth by a factor of 10 reduces the overall sweep time by the same factor. In some cases, the tuning increment may be controlled such that it is irregular or variable over a given frequency range.

In some embodiments, the linewidth control signal is dynamic and can vary over a sweep of the spectrum being measured. This dynamic nature of the linewidth control signal allows for the dynamic modification of the linewidth of the tunable laser over a sweep. This is advantageous as some instruments demonstrate a linewidth that varies with central laser frequency. Upon changes in the linewidth, microcontroller 33 is configured to apply a corresponding change to the laser tuning increment to match the current linewidth.

The above linewidth broadening technique provides the potential to perform extremely fast spectral sweeps in an HR-OCM or OSA type heterodyne measurement device. Using appropriate linewidth control signals, a linewidth of ˜100 MHz can be artificially and selectively broadened to 1 GHz, 10 GHz or even higher if necessary depending on the measurement application. By way of example, in the C-band, with a range of 5.2 THz, if a linewidth and tuning increment of 1 GHz is chosen, the Finisar WaveAnalyzer 1500S High-Resolution Optical Spectrum Analyzer can offer a refresh rate of around 39 to 40 Hz. Over a more practical spectral range, of 400 GHz, this sweep speed increases to 500 Hz. Similarly, if the linewidth is broadened to 10 GHz and the tuning increment increased to match this, a sweep over the C-band can be performed with a refresh rate of about 390 to 400 Hz.

The above sweep control technique can be performed entirely using existing hardware by programming the microcontroller 33 to perform method 400 using existing control signals. In some embodiments, an additional signal generation device is integrated onto the substrate 25 for providing the linewidth control signal.

In some embodiments, the sweep control technique can be performed during manufacture as an initial calibration technique or a subsequent recalibration after a period of operation of the device. In other embodiments, the sweep control technique is performed dynamically throughout operation of the heterodyne device. The dynamic capability is provided through a user interface of an associated computer system integrated with the device or connected to the device through an RS 232 or other electrical connection. Using the interface, a user is able to provide user input to vary the linewidth control signal and hence the linewidth and tuning increment. Exemplary user input includes a desired resolution of the spectral sweep, start and end points of the sweep in the frequency domain or a maximum sweep time or refresh rate.

Microcontroller 33 accesses relevant lookup tables which store relationships between user inputs and corresponding voltage or current values to apply to linewidth control signal 54 and the input control signals 27 to achieve the desired linewidth and sweep rates.

The linewidth broadening effect can be tailored for each device based on the desired measurement application. Driven from an FPGA, the broadening effect can change on the same order as the laser dwell time, enabling very fast changes in the effective resolution bandwidth of the HR-OCM.

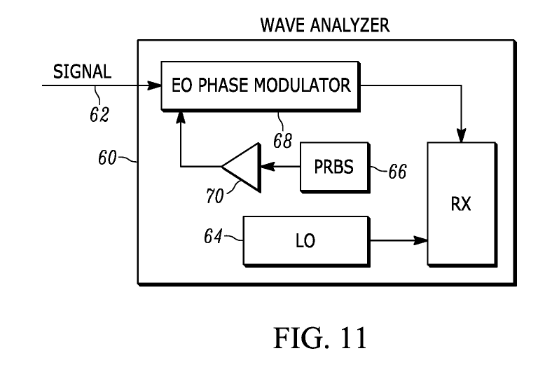

In some circumstances, it may be undesirable for a heterodyne measurement device to incorporate spectral broadening on the local oscillator. FIG. 11 illustrates schematically an alternative embodiment directed to OSAs such as the Finisar WaveAnalyzer 1500S High-Resolution Optical Spectrum Analyzer 60 in which spectral broadening is applied to the input signal 62 as opposed to the local oscillator 64. In this embodiment, an amplified PRBS signal 66, as an example of a linewidth control signal, is modulated with input signal 62 using an electro-optic phase modulator 68 to controllably broaden the input signal 62. This embodiment can be advantageous for low coherence measurement applications. For these applications, linewidth broadening allows a narrow linewidth input signal to be broadened enough so that it can be captured with a larger tuning increment during a sweep.

Modulator 68 and an amplifier 70 for amplifying the PRBS signal can be made from off-the-shelf parts, and the PRBS signal could either be generated on the WaveAnalyzer motherboard, or by an integrated circuit such as the ADN2915.

### CONCLUSIONS

The preferred embodiments of the present invention use electronic linewidth broadening of a semiconductor laser to artificially and controllably increase the resolution bandwidth of optical spectral measurements in the HR-OCM while maintaining a continuous sweep across the desired spectrum to be monitored. The tuning increment can be increased in proportion to the increase in resolution bandwidth to reduce the overall sweep time of the system. Additionally, the broader resolution bandwidth can lead to an improvement in power repeatability.

### Interpretation

It will be understood by one skilled in the art that the frequency and wavelength of a laser beam are connected by the equation:

Speed of light=wavelength*frequency.

As a consequence, when reference is made to frequency shifting, frequency converting, frequency broadening, different frequencies and similar terms, these are interchangeable with the corresponding terms wavelength shifting, wavelength converting, wavelength broadening, different wavelengths and the like.

Throughout this specification, use of the term “element” is intended to mean either a single unitary component or a collection of components that combine to perform a specific function or purpose.

The terms “processor” or “microprocessor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to include, but not be limited to, solid-state memories, a computer product embodied in optical and magnetic media; a medium bearing a propagated signal detectable by at least one processor or one or more processors and representing a set of instructions that, when executed, implement a method; and a transmission medium in a network bearing a propagated signal detectable by at least one processor of the one or more processors and representing the set of instructions.

It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A method of controlling an optical heterodyne measurement system, the measurement system having a tunable laser for generating a local oscillator signal, an optical input for receiving an input optical signal and a mixing module for mixing the local oscillator signal with the input optical signal to generate an output optical measurement signal; the method including the steps of:
a) receiving an input electrical drive signal for driving the tunable laser to produce a laser output having a spectral linewidth and peak central frequency, an initial spectral linewidth of the laser output having a first spectral width;
b) coupling the input electrical drive signal with a linewidth control signal to selectively broaden the spectral linewidth to a second spectral width; and
c) during a measurement period, selectively tuning the central frequency of the laser in a stepwise manner across a predetermined frequency spectrum at predefined tuning increments.

2. A method according to claim 1 wherein the tuning increment is defined based on the second spectral width.

3. A method according to claim 2 wherein the tuning increment is in the range of 0.5 to 1.5 times the second spectral width.

4. A method according to claim 3 wherein the tuning increment is equal to the second spectral width.

5. A method according to claim 1 wherein the linewidth control signal is based on user input indicative of a desired scan time or refresh rate of the optical heterodyne measurement system.

6. A method according to claim 1 wherein the linewidth control signal includes a pseudo random bit function.

7. A method according to claim 1 wherein the linewidth control signal includes a repeating triangular function.

8. A method according to claim 1 wherein the linewidth control signal includes a sinusoidal function.

9. A method according to claim 1 wherein the input electrical drive signal controls the gain of the tunable laser.

10. A method according to claim 1 wherein the electrical drive signal controls the phase of the tunable laser.

11. A method according to claim 1 wherein the second spectral width is proportional to the amplitude of the linewidth control signal.

12. A method according to claim 1 wherein the second spectral width is 5 to 100 times greater than the first spectral width.

13. A method according to claim 1 wherein the linewidth control signal also modifies a spectral profile of the laser.

14. A method according to claim 13 wherein the linewidth control signal flattens the spectral profile of the laser.

15. A method according to claim 1 wherein the tuning increment is variable over a given frequency range.

16. A method according to claim 1 wherein step b) includes modulating the input electrical drive signal with the linewidth control signal.

17. (canceled)

18. A method according to claim 17 wherein the linewidth control signal varies as a function of the central frequency of the tunable laser so as to vary the second spectral width during the measurement period.

19. A control system for an optical heterodyne measurement system, the measurement system having a tunable laser for generating a local oscillator signal, an optical input for receiving an input optical signal and a mixing module for mixing the local oscillator signal with the input optical signal to generate an output optical measurement signal, the control system including:
a drive module for producing an input electrical drive signal for driving the tunable laser to produce an optical output having a spectral linewidth and peak central frequency, an initial spectral linewidth of the optical output having a first spectral width;
a linewidth tuning module for coupling the input electrical drive signal with a linewidth control signal to selectively broaden the spectral linewidth to a second spectral width; and
a tuning module for selectively tuning the central frequency of the laser in a stepwise manner across a predetermined frequency spectrum.

20. A control system according to claim 19 wherein the tuning module selectively tunes the central frequency at integer multiples of a tuning increment, wherein the tuning increment is defined based on the second spectral width.

21. (canceled)

22. A method of calibrating a tunable laser including the steps of:
a) performing a first measurement of a spectral linewidth of an output of the laser;
b) coupling the input electrical drive signal with an electrical control signal to selectively broaden the spectral linewidth;
c) performing a second measurement of the spectral linewidth;
d) defining a tuning increment based on the second measurement such that, during operation, the central frequency of the laser is incrementally tuned in a stepwise manner across a predetermined frequency spectrum at integer multiples of the tuning increment.

23. (canceled)
